(19) United States
(12) Patent Application Publication
(10) Pub. No.: US 2012/0241370 A1
(43) Pub. Date: Sep. 27, 2012

(54) CENTRIFUGAL FILTER

(75) Inventors: Jiyue Yang, Guangdong (CN); Hongbin Huang, Guangdong (CN); Weiquan Fu, Guangdong (CN)

(73) Assignee: Guangdong Liansu Technology Industrial Co. Ltd.

(21) Appl. No.: 13/514,035

(22) PCT Filed: Aug. 9, 2011
(86) PCT No.: PCT/CN2011/078136

§ 371 Date: Jun. 5, 2012

(30) Foreign Application Priority Data
Nov. 19, 2010 (CN) 201010551114.7

(51) Int. Cl. B01D 29/88

(52) U.S. Cl. 210/435

(57) ABSTRACT

A centrifugal filter is provided comprising a water inlet pipe, an overflow pipe, a flow guiding device, a filter body with a cover, and a sedimentation container. The water inlet pipe is mounted on the filter body in tangential direction of the filter body, and the sedimentation container is in fluid communication with the bottom of the filter body. The overflow pipe is disposed above the cover of the filter body with the flow guiding device disposed below the cover, and the flow guiding device is in fluid communication with the overflow pipe. The incoming water from the inlet pipe enters into the filter along the sidewall of the filter body in tangential direction, so that the incoming water rotates around the conical outer surface of the flow guiding device and moves downwards, thus the rotational radius of the water stream is increased. A rotation momentum around the axis of the filter body is generated to generate centrifugal force to separate solid particles from the water stream. A momentum toward away from the axis of the filter body is generated to eliminate short circuit flows and overcome separation efficiency decrease problems caused by the short circuit flows.

### TECHNICAL FIELD

The present invention relates to an irrigation device in agriculture, and in particular, to a centrifugal filter.

### TECHNICAL BACKGROUND

Centrifugal filters are widely used in agricultural irrigation. For example, China patent No. 98240446.8 discloses a combined filter which comprises a filter tube upon which is mounted a flow guiding device. The flow guiding device is capped by a cover at the top and provided with an outlet at one side with a pressure meter connector disposed thereon. In the flow guiding device, there is disposed a mesh in the shape of a filter body.

Short circuit flow is one of the main characteristic stream flows in the filter of this type, which is a key factor causing coarse particles existing in overflow and fine particles existing in separated residues. Short circuit flow is inevitable in conventional sand filter due to the structure of the flow guiding device used therein. The separation efficiency, flow capacity and energy loss at the outlet of the filter are affected by the structure of the flow guiding device. That is to say, the structure form of the flow guiding device has direct effect on the overall performance of the sand filter.

Short circuit flows in conventional sand filter include cover short circuit flows and sidewall short circuit flows. When the solid content of water stream is at moderate concentration, an eddy would be formed under the cover to inhibit short circuit flow, which facilitates separation the filter. With respect to sidewall short circuit flow, since radial pulsation is present in the interface layer of the sidewall, solid particles in the short circuit flows would separate from some of the short circuit flows and enter into the flow guiding device. In this case, coarser particles are present in the overflow where they are not supposed to be present, such that the separation efficiency is decreased.

FIG. 8 shows the isograms of velocity of flow field for conventional centrifugal sand filter. FIG. 9 shows the vector distribution diagram of velocity of low field for conventional centrifugal sand filter. Fluid mechanics analysis has shown that a part of sidewall short circuit flows that in proximity with the flow guiding device directly flow into the latter. Moreover, the sidewall short circuit flows tend to have a larger solid concentration. Experimental tests have also demonstrated this fact.

Therefore, the most efficient method for improving the separation efficiency of the sand filter is to eliminate or reduce sidewall short circuit flows.

### SUMMARY OF THE INVENTION

An object of the present invention is to provide a centrifugal sand filter that is efficient in sidewall short circuit flow elimination or reduction and has relatively high separation efficiency.

To achieve the object, a centrifugal filter is provided comprising a water inlet pipe, an overflow pipe, a flow guiding device, a filter body with a cover, and a sedimentation container, the water inlet pipe being mounted on the filter body in tangential direction of the filter body, the sedimentation container being in fluid communication with the bottom of the filter body, the overflow pipe being disposed above the cover of the filter body with the flow guiding device disposed below the cover, the flow guiding device being in fluid communication with the overflow pipe, and the flow guiding device having a conical outer contour.

The incoming water from the inlet pipe enters into the filter along the sidewall of the filter body in tangential direction, so that the incoming water rotates around the conical outer surface of the flow guiding device and moves downwards, thus the rotational radius of the water stream is increased.

The flow of the water stream can be divided into two flow patterns, with one flow pattern being circle movement around the axis of the flow guiding device, named with movement “a”, and the other flow pattern being slant downward movement along the slant surface of the flow guiding device, named with movement “b”. The movement “b” can be further divided into two additional movements, with one movement being downward movement along the axis of the filter, named with movement “c”, and the other being radial movement towards the sidewall of the filter body, named with movement “d”.

The combined movements of “a”, “c” and “d” cause the incoming water stream to be thrown to the sidewall of the filter body. The movement “a” generates rotation momentum around the axis of the filter body for the water stream, so as to generate centrifugal force to separate solid particles from the water stream. The combined movements of “c” and “d” generate momentum toward away from the axis of the filter body, so as to eliminate short circuit flows and overcome separation efficiency decrease problems caused by the short circuit flows.

As a further improvement, the flow guiding device includes an inner cylinder that has a same inner diameter with that of the overflow pipe. The filtered water flows from the inner cylinder into the overflow pipe with reduced resistance, so as to achieve fast output.

As a further improvement, the flow guiding device further includes an upper conical body and a lower conical body with both of the conical bodies coaxially disposed with the inner cylinder. The upper base of the inner cylinder coincides with the small diameter base of the upper conical body, and the lower base of the inner cylinder coincides with the small diameter base of the lower conical body. The large diameter base of the upper conical body coincides with the large diameter base of the lower conical body. A circular space is defined by the outer surface of the inner cylinder, the upper conical body and the sidewall of the lower conical body, such that materials can be saved when manufacturing and a more stable structure is obtained.

As a further improvement, the flow guiding device further includes an upper conical body and a circular plate that are coaxially disposed with the inner cylinder. The upper base of the inner cylinder coincides with the small diameter base of the upper conical body, and the lower base of the inner cylinder coincides with the inner circular surface of the circular plate. The large diameter base of the upper conical body coincides with the outer circular surface of the circular plate. A circular space is defined by the outer surface of the inner cylinder, the upper conical body and the circular plate, such that materials can be saved when manufacturing and a more stable structure is obtained.

As a further improvement, the outer surface of the upper conical body is a curved surface, and the generator of the outer surface is thus a curved line.

As a further improvement, a hollow convex is disposed at one side of the sedimentation container, with a sealing cover detachably mounted on the hollow convex. The sealing cover is detachable so as to facilitate cleaning of the sediments in the container.

As a further improvement, a column with internal screw thread is placed in the hollow convex, and a bolt passes through a through hole on the sealing cover and engages with the internal screw thread. It is simple and convenient to use bolts to fix the sealing cover.

As a further improvement, a sealing ring is provided between the bolt and the through hole of the sealing cover.

As a further improvement, a handle is secured to the distal end of the bolt.

As a further improvement, a sealing ring is provided between the convex and the sealing cover.

The filter of the present invention is provided with a conical flow guiding device, so that the flow direction of water stream is changed and short circuit flows are eliminated, which efficiently improves the separation efficiency of the filter.

### BRIEF DESCRIPTION OF THE DRAWINGS

FIG. 1 is a schematic view of a filter in accordance with one embodiment of the present invention.

FIG. 2 is a sectional view of the filter along A-A line.

FIG. 3 is a sectional view of the filter along B-B line.

FIG. 4 is a sectional view of partial structure of the flow guiding device according to the first example of the invention.

FIG. 5 is a perspective view of a flow guiding device according to one example of the invention.

FIG. 6 is a schematic view of a flow guiding device according to another example of the invention.

FIG. 7 is a schematic view of a flow guiding device according to yet another example of the invention.

FIG. 8 shows the isograms of velocity of flow field for conventional centrifugal sand filter.

FIG. 9 shows the vector distribution diagram of velocity of low field for conventional centrifugal sand filter.

FIG. 10 shows the isograms of velocity of flow field for the centrifugal sand filter of the present invention.

FIG. 11 shows the vector distribution diagram of velocity of low field for the centrifugal sand filter of the present invention.

### LIST OF REFERENCE NUMERALS

1—water inlet pipe; 2—overflow pipe; 3—flow guiding device; 31—inner cylinder; 32—upper conical body; 33—lower conical body; 321—outer surface of the upper conical body; 4—filter body with a cover; 5—sedimentation container; 51—hollow convex; 52—sealing cover; 53—column with internal screw thread; 54—bolt; 55—handle; 56—sealing ring; 57—sealing ring.

### DETAILED DESCRIPTION OF THE PREFERABLE EMBODIMENT

### Example 1

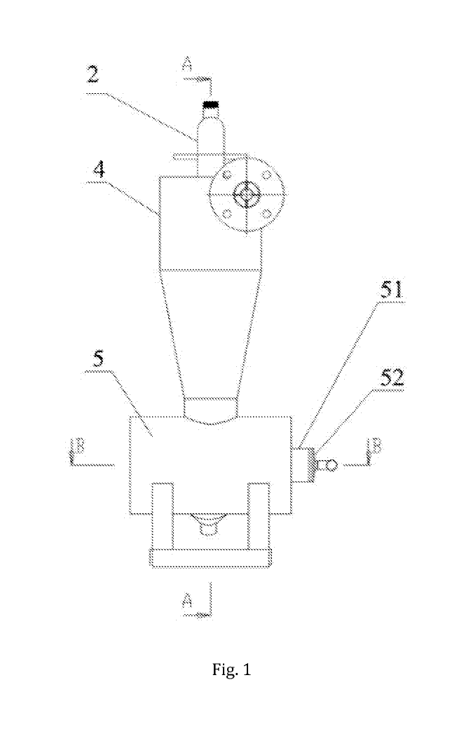

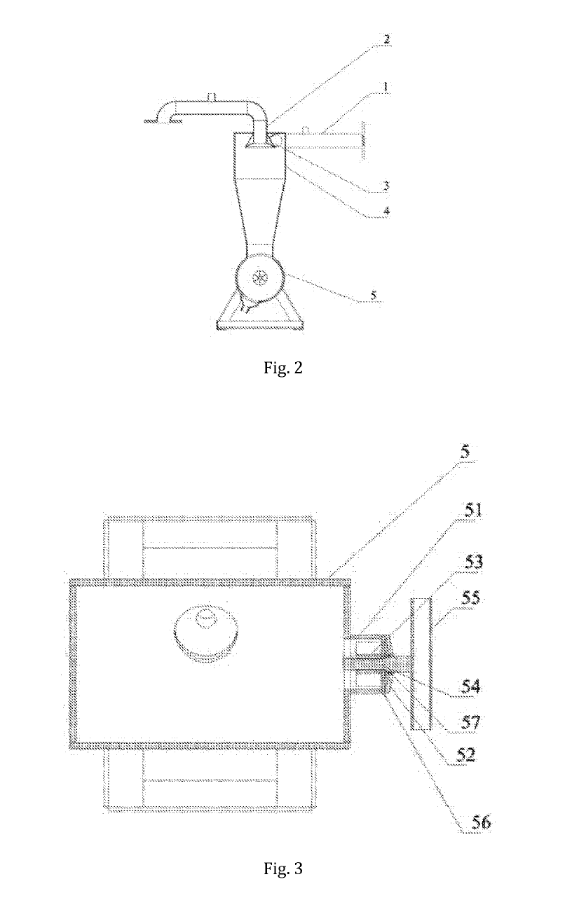

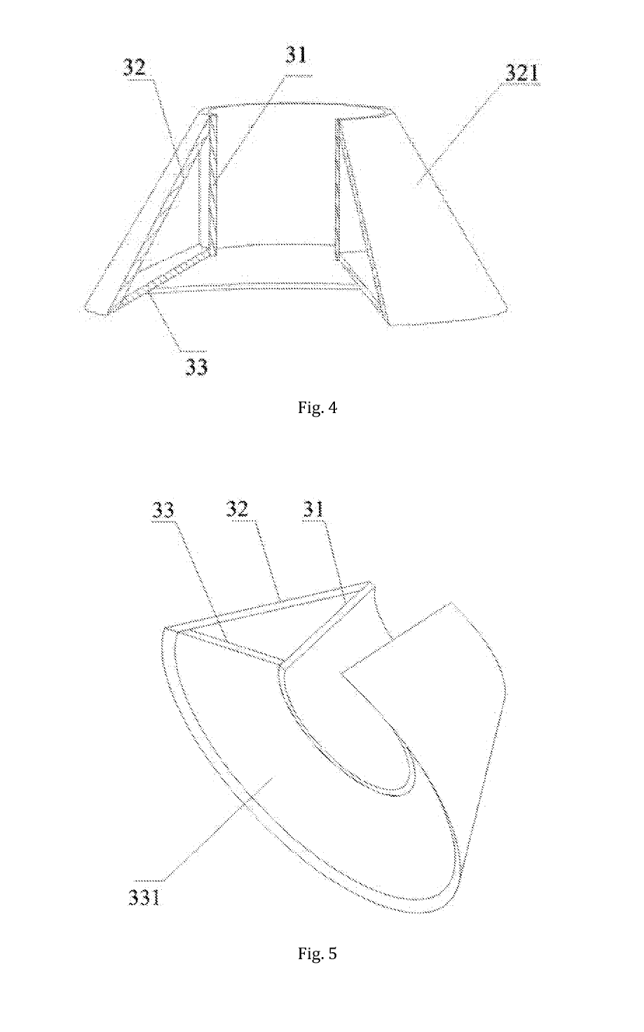

As shown in FIGS. 1 to 5, a centrifugal filter is provided which comprises a water inlet pipe 1, an overflow pipe 2, a flow guiding device 3, a filter body 4 with a cover, and a sedimentation container 5. The water inlet pipe 1 is mounted on the filter body 4 in tangential direction of the filter body 4. The sedimentation container 5 is in fluid communication with the bottom of the filter body 4. The overflow pipe 2 is disposed above the cover of the filter body 4 with the flow guiding device 3 disposed below the cover.

The flow guiding device 3 includes an inner cylinder 31, an upper conical body 32 and a lower conical body 33, with the cylinder 31 and the conical bodies 32, 33 coaxially disposed. The upper base of the inner cylinder 31 coincides with the small diameter base of the upper conical body 32, and the lower base of the inner cylinder 31 coincides with the small diameter base of the lower conical body 33. The inner diameter of the inner cylinder 31 equals to the inner diameter of the overflow pipe 2, and the inner cylinder 31 is in fluid communication with the overflow pipe 2.

A hollow convex 51 is disposed at one side of the sedimentation container 5, with a sealing cover 52 detachably mounted on the hollow convex 51. A column 53 with internal screw thread is placed in the hollow convex 51. A bolt 54 passes through a through hole on the sealing cover 52 and engages with the internal screw thread, so that the outlet of the convex 51 is sealed by the sealing cover 52.

A handle 55 is secured to the distal end of the bolt 54. Sealing materials 57, 56 are disposed between the bolt 54 and the sealing cover 52, and between the convex 51 and the sealing cover 52.

The incoming water from the inlet pipe 1 enters into the filter along the sidewall of the filter body 4 in tangential direction, so that the incoming water rotates around the conical outer surface of the flow guiding device 3 and moves downwards, thus the rotational radius of the water stream is increased.

The flow of the water stream can be divided into two flow patterns, with one flow pattern being circle movement around the axis of the flow guiding device 3, named with movement “a”, and the other flow pattern being slant downward movement along the slant surface of the flow guiding device, named with movement “b”. The movement “b” can be further divided into two additional movements, with one movement being downward movement along the axis of the filter, named with movement “c”, and the other being radial movement towards the sidewall of the filter body, named with movement “d”.

The combined movements of “a”, “c” and “d” cause the incoming water stream to be thrown to the sidewall of the filter body. The movement “a” generates rotation momentum around the axis of the filter body for the water stream, so as to generate centrifugal force to separate solid particles from the water stream. The combined movements of “c” and “d” generate momentum toward away from the axis of the filter body, so as to eliminate short circuit flows and overcome separation efficiency decrease problems caused by the short circuit flows.

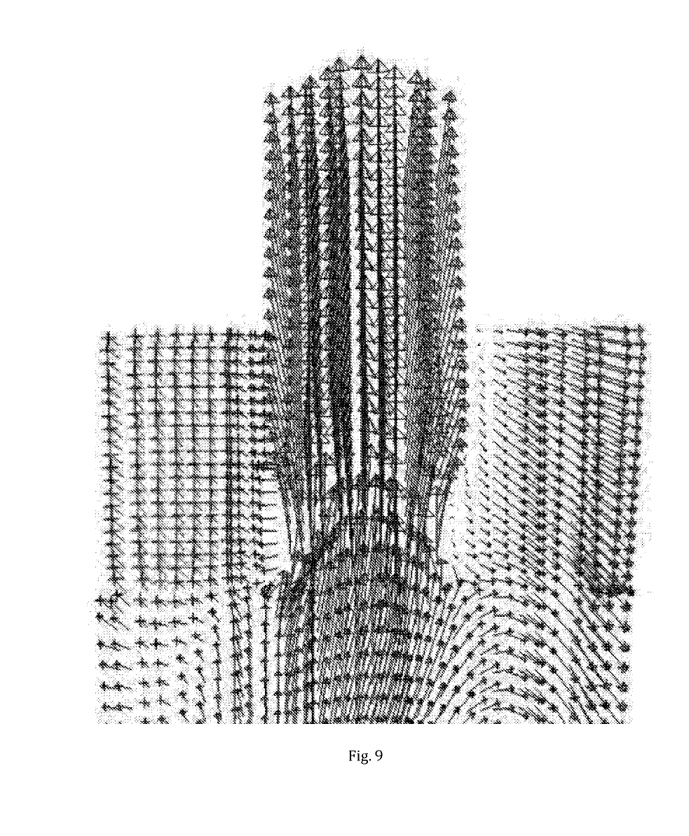

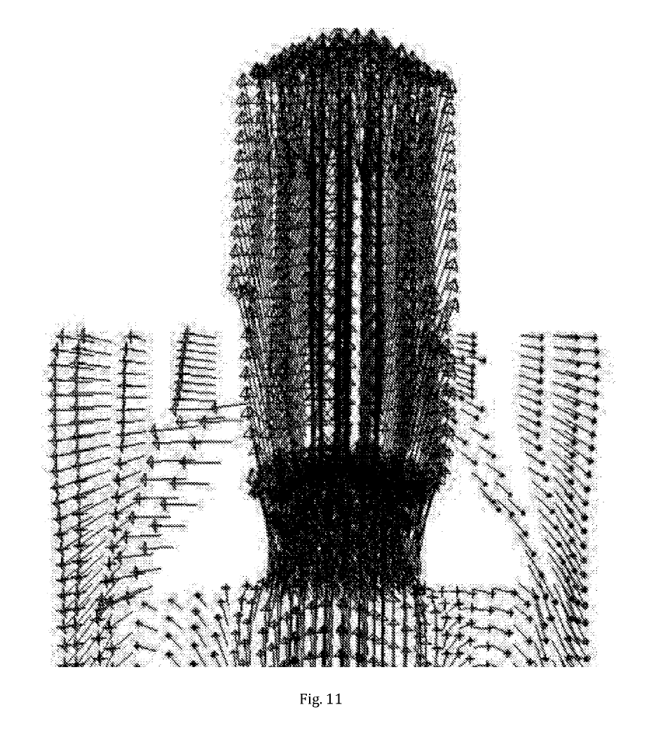

FIG. 10 shows the isograms of velocity of flow field for the centrifugal sand filter of the present invention. FIG. 11 shows the vector distribution diagram of velocity of low field for the centrifugal sand filter of the present invention.

### Example 2

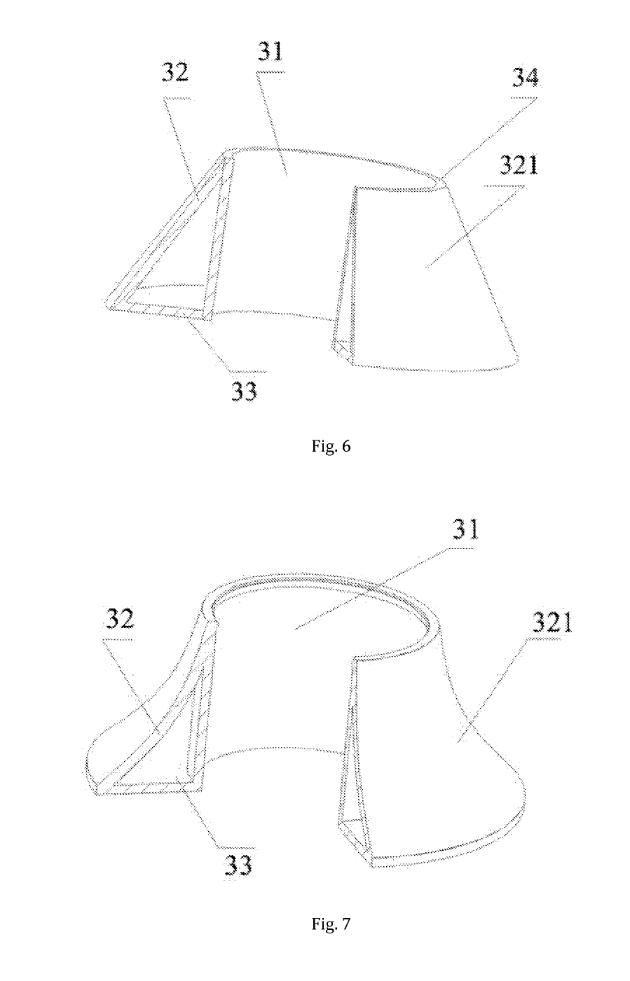

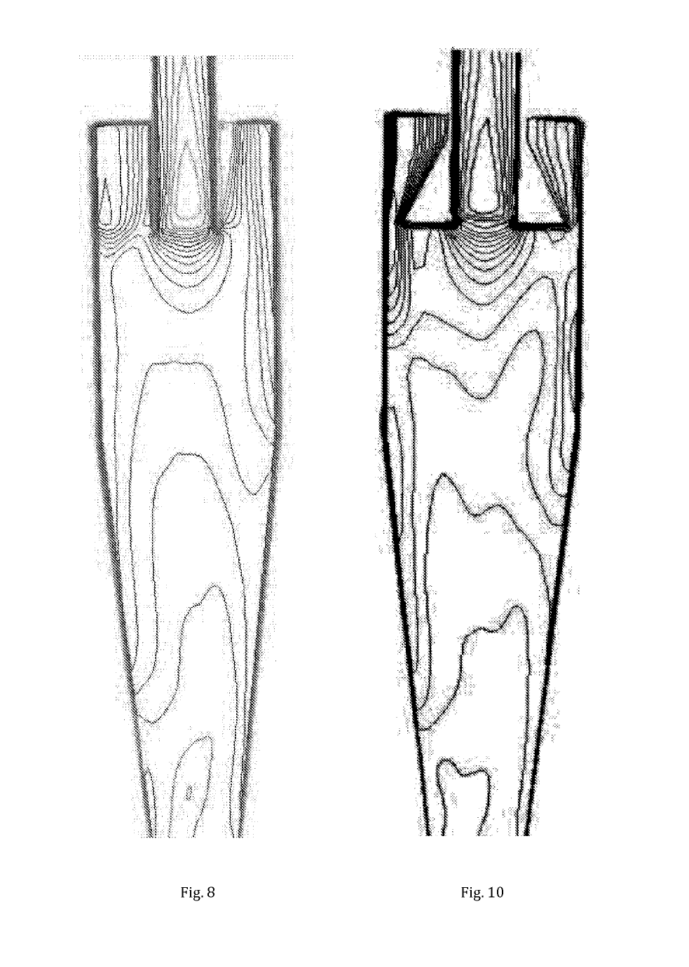

The filter provided in example 2 is substantially similar to example 1 except that the lower conical body 33 is substituted with a circular plate 33. As shown in FIG. 6, the upper base of the inner cylinder 31 coincides with the small diameter base of the upper conical body 32, and the lower base of the inner cylinder 31 coincides with the inner circular surface of the lower conical body 33. The large diameter base of the upper conical body 32 coincides with the outer circular surface of the lower conical body 33.

The inner diameter of the inner cylinder 31 equals to the inner diameter of the overflow pipe 2, and the inner cylinder 31 is in fluid communication with the overflow pipe 2.

### Examlpe 3

As shown in FIG. 7, the filter in this example differs from example 1 or 2 in that the outer surface 321 of the upper conical body 32 of the flow guiding device 3 is a curved surface, the generator of the outer surface 321 is thus a curved line.

What is claimed is:

1. A centrifugal filter comprising a water inlet pipe (1), an overflow pipe (2), a flow guiding device (3), a filter body (4) with a cover, and a sedimentation container (5), wherein the water inlet pipe (1) is mounted on the filter body (4) along a tangential direction of the filter body (4), and the sedimentation container (5) is in fluid communication with the bottom of the filter body (4), wherein the overflow pipe (2) is disposed above the cover of the filter body (4) with the flow guiding device (3) disposed below the cover, and the flow guiding device (3) is in fluid communication with the overflow pipe (2), and wherein the flow guiding device (3) has a conical outer contour.

2. The centrifugal filter of claim 1, wherein the flow guiding device (3) includes an inner cylinder (31) having a same inner diameter with that of the overflow pipe (2).

3. The centrifugal filter of claim 2, wherein the flow guiding device (3) further includes an upper conical body (32) and a lower conical body (33) with both of the conical bodies coaxially disposed with the inner cylinder (31), wherein the upper base of the inner cylinder (31) coincides with the small diameter base of the upper conical body (32), and the lower base of the inner cylinder (31) coincides with the small diameter base of the lower conical body (33), and wherein the large diameter base of the upper conical body (31) coincides with the large diameter base of the lower conical body (33).

4. The centrifugal filter of claim 2, wherein the flow guiding device (3) further includes an upper conical body (32) and a circular plate (33) that are coaxially disposed with the inner cylinder (31), wherein the upper base of the inner cylinder (31) coincides with the small diameter base of the upper conical body (32), and the lower base of the inner cylinder (31) coincides with the inner circular surface of the circular plate (33), and wherein the large diameter base of the upper conical body (32) coincides with the outer circular surface of the circular plate (33).

5. The centrifugal filter of claim 3, wherein the outer surface (321) of the upper conical body (32) is a curved surface, and the generator of the outer surface (321) is thus a curved line.

6. The centrifugal filter of claim 5, wherein a hollow convex (51) is disposed at one side of the sedimentation container (5), with a sealing cover (52) detachably mounted on the hollow convex (51).

7. The centrifugal filter of claim 6, wherein a column (53) with internal screw thread is placed in the hollow convex (51), and a bolt (54) passes through a through hole on the sealing cover (52) and engages with the internal screw thread.

8. The centrifugal filter of claim 7, wherein a sealing ring (57) is provided between the bolt (54) and the through hole of the sealing cover (52).

9. The centrifugal filter of claim 7, wherein a handle (55) is secured to the distal end of the bolt (54).

10. The centrifugal filter of claim 9, wherein a further sealing ring (56) is provided between the convex (51) and the sealing cover (52).
